(19) United States
(12) Patent Application Publication
(10) Pub. No.: US 2009/0315986 A1
(43) Pub. Date: Dec. 24, 2009

(54) ENDOSCOPE APPARATUS

(75) Inventor: Jin Ohara, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/485,194

(22) Filed: Jun. 16, 2009

(30) Foreign Application Priority Data
Jun. 18, 2008 (JP) JP 2008-159136
Apr. 27, 2009 (JP) JP 2009-107546

(51) Int. Cl. H04N 7/18

(52) U.S. Cl. 348/65; 348/E07.085

(57) ABSTRACT

An endoscope apparatus has an image pickup element, an image pickup element housing tube that houses the image pickup element, a heat transfer member that is in contact with the image pickup element and the image pickup element housing tube, and a resin that seals the interior of the image pickup element housing tube and is in contact with the image pickup element. The heat transfer member has a heat conductivity higher than that of the resin.

### CROSS-REFERENCE TO RELATED APPLICATION

The present application is based upon and claims the benefit of priority from the prior Japanese Patent Application Nos. 2008-159136 filed on Jun. 18, 2008 and 2009-107546 filed on Apr. 27, 2009; the entire contents of which are incorporated herein by reference.

### BACKGROUND OF THE INVENTION

1. Field of the Invention

The present invention relates an endoscope apparatus.

2. Description of the Related Art

With advancement of the performance of the image pickup element used in an endoscope, electric power required in the endoscope, for example, to drive and control the image pickup element will increase. This is expected to lead to an increase in the quantity of heat generated in the image pickup element and the surrounding of the image pickup element as compared to that in the past. Since heat generated in the image pickup element and its surrounding will cause noise in the picked-up image, avoidance of heat and/or cooling is needed. In the end portion of the endoscope, there is a possibility that heat is generated not only by the image pickup element but also by an illumination apparatus etc. For example, it is expected that the light emission efficiency of an LED will be decreased due to heat generated by the LED itself, and the heat will be transferred to the image pickup element.

A prior art endoscope that can avoid or cool generated heat is disclosed in Japanese Patent Application Laid-Open No. 2003-334156. This endoscope apparatus has a Peltier device provided on the backside of an image pickup element to be cooled.

However, in the endoscope apparatus described in Japanese Patent Application Laid-Open No. 2003-334156, discharge of heat absorbed by the Peltier device is not taken into consideration. Therefore, if a sufficient heat sink effect is to be achieved in this endoscope apparatus, it is necessary to use a large-scale heat sink system that is generally used. Nonetheless, it is difficult to provide a large-scale heat sink system that enables sufficient heat sink in the endoscope apparatus. In addition, in the environment in which the endoscope is used, it is difficult to use a large Peltier device including a cooling system, and therefore cooling capability thereof may be insufficient in some cases. On the other hand, if a Peltier device is used alone, effective cooling cannot be expected because heat generated on the heat dissipation surface of the Peltier device will become large, or this may adversely lead to an increase in the temperature.

### SUMMARY OF THE INVENTION

The present invention has been made in view of the above-described situations and has as an object to cool an image pickup element provided at the end of an endoscope apparatus. According to the present invention, the image pickup element is cooled by transferring heat in the image pickup element provided in the endoscope apparatus in a radial direction(s)

To solve the above-described problem and achieve the object, an endoscope apparatus according to the present invention comprises an image pickup unit, an image pickup element housing tube that houses the image pickup unit, a heat transfer member that is in contact with the image pickup unit and the image pickup element housing tube, and a resin that is in contact with the image pickup unit and seals the interior of the image pickup element housing tube, wherein the heat transfer member has a heat conductivity higher than that of the resin.

In the endoscope apparatus according to the present invention, it is preferred that the heat transfer member be a flexible sheet-like structure.

In the endoscope apparatus according to the present invention, it is preferred that the image pickup element housing tube and a member disposed radially outside the image pickup element housing tube in the endoscope apparatus be in contact with a heat dissipation member having a heat conductivity higher than that of the image pickup element housing tube.

In the endoscope apparatus according to the present invention, the transfer member may be composed of a Peltier device and a flexible sheet-like structure.

In the endoscope apparatus according to the present invention, it is preferred that the heat transfer member and the heat dissipation member be opposed to each other with the image pickup element housing tube between.

In the endoscope apparatus according to the present invention, it is preferred that the member disposed radially outside the image pickup element housing tube be a water supply tube.

In the endoscope apparatus according to the present invention, the heat dissipation member may be composed of a Peltier device and a flexible sheet-like structure.

In the endoscope apparatus according to the present invention, it is preferred that the heat transfer member include a Peltier device that is in contact with the image pickup unit and a first heat transfer member that is in contact with the Peltier device at one end and extends in a radial direction of the image pickup element housing tube, the inner wall surface of the image pickup element housing tube be in contact with the other end of the first heat transfer member, and the image pickup unit, the Peltier device, and the first heat transfer member be sealed by the resin in the image pickup element housing tube.

In the endoscope apparatus according to the present invention, it is preferred that the Peltier device have a cooling surface that is in contact with the image pickup unit and a heat dissipation surface that is in contact with one end of the first heat transfer member.

It is preferred that the endoscope apparatus according to the present invention be further provided with a heat exchange system that is in contact with the outer wall surface of the image pickup element housing tube.

It is preferred that the endoscope apparatus according to the present invention be further provided with a second heat transfer member that is in contact with the outer wall surface of the image pickup element housing tube at one end and extends in a radial direction of the image pickup element housing tube, and a heat exchange system that is in contact with the other end of the second heat transfer member.

In the endoscope apparatus according to the present invention, it is preferred that the first heat transfer member and the second heat transfer member be flexible.

In the endoscope apparatus according to the present invention, it is preferred that the first heat transfer member and the second heat transfer member be graphite sheets.

In the endoscope apparatus according to the present invention, it is preferred that the first heat transfer member have a heat conductivity higher than that of the resin.

In the endoscope apparatus according to the present invention, it is preferred that the heat exchange system be composed of a water cooling system and a tube.

In the endoscope apparatus according to the present invention, it is preferred that the water cooling system be a structure that is made of a metal and has a flow channel, which is hollow.

In the endoscope apparatus according to the present invention, it is preferred that the first heat transfer member and the water cooling system be opposed to each other with an inner wall surface and an outer wall surface of the image pickup element housing tube between.

### BRIEF DESCRIPTION OF THE DRAWINGS

FIG. 1 is a diagram showing the configuration of an endoscope system according to a first embodiment;

FIG. 2 is a cross sectional view taken on a plane perpendicular to the longitudinal direction, showing the internal structure of the end portion of the endoscope according to the first embodiment;

FIG. 3 is a longitudinal cross sectional view showing the internal structure of the end portion of the endoscope according to the first embodiment;

FIG. 4 is a cross sectional view taken on a plane perpendicular to the longitudinal direction, showing an endoscope of a comparative example;

FIG. 5 is a cross sectional view taken on a plane perpendicular to the longitudinal direction, showing the internal structure of the end portion of an endoscope according to a second embodiment;

FIG. 6 is a longitudinal cross sectional view showing the internal structure of the end portion of the endoscope according to the second embodiment;

FIG. 7 is a diagram showing an endoscope according to a third embodiment;

FIG. 8 is a longitudinal cross sectional view showing the internal structure of the end portion of the endoscope according to the third embodiment;

FIG. 9 is a longitudinal cross sectional view showing the internal structure of the end portion of an endoscope according to a fourth embodiment;

FIG. 10 is a cross sectional view taken on a plane perpendicular to the longitudinal direction, showing the internal structure of the end portion of the endoscope according to the fourth embodiment;

FIG. 11 is a perspective view showing the structure of a heat exchange system according to the fourth embodiment;

FIG. 12 is a longitudinal cross sectional view showing the internal structure of the end portion of an endoscope according to a fifth embodiment;

FIG. 13 is a cross sectional view taken on a plane perpendicular to the longitudinal direction, showing the internal structure of the end portion of the endoscope according to the fifth embodiment.

### DETAILED DESCRIPTION OF THE INVENTION

In the following, embodiments of the endoscope apparatus according to the present invention will be described in detail with reference to the accompanying drawings. It should be understood that the present invention is not limited to the embodiments.

### First Embodiment

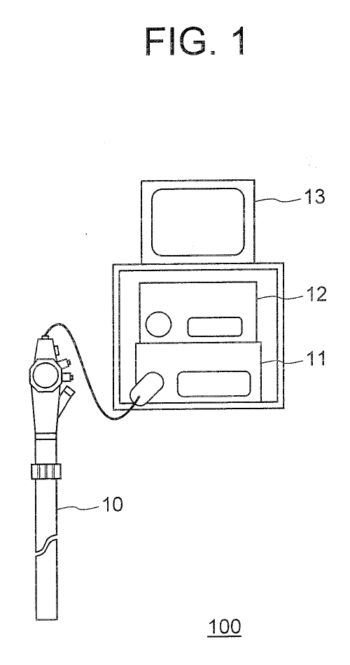

As shown in FIG. 1, an endoscope system 100, or an observing apparatus used to look inside a body of an examinee, has an endoscope 10, a light source device 11, a video processor 12, and a monitor 13. FIG. 1 is a diagram showing the configuration of the endoscope system according to the first embodiment. The endoscope 10 (the endoscope apparatus) is an apparatus having means to be inserted into the body of the examinee for picking up an image in the interior of the body, taking living cells, and performing a treatment. The light source device 11, the video processor 12, and the monitor 13 are connected electrically and mechanically with the endoscope 10 and have respective functions. Specifically, the light source device 11 is a device that drives a light source to emit light from the endoscope 10. The video processor 12 is configured to process images sent from the endoscope 10 and provides processing and synchronization of circuits. The monitor 13 is used to output or display images obtained by the endoscope 10.

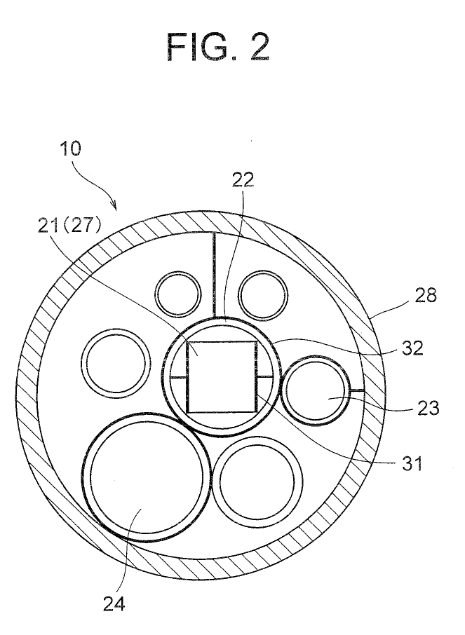

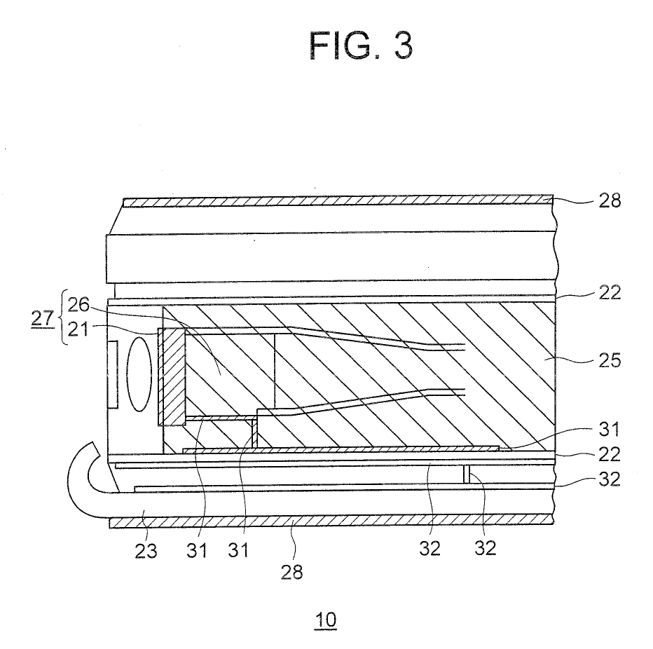

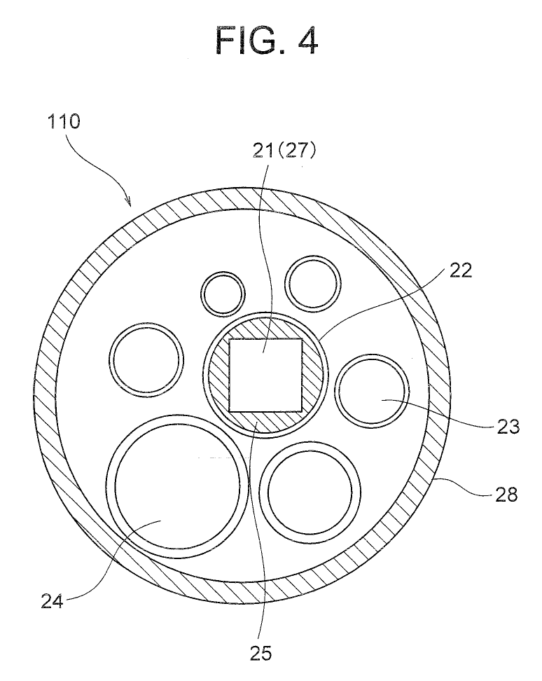

In the following, the portion of the endoscope 10 relevant to its image pickup element will be described with reference to FIG. 2 to FIG. 4. FIG. 2 is a cross sectional view taken on a plane perpendicular to the longitudinal direction, showing the internal structure of the end portion of the endoscope 10 according to the first embodiment. FIG. 3 is a longitudinal cross sectional view showing the internal structure of the end portion of the endoscope 10. FIG. 4 is a cross sectional view taken on a plane perpendicular to the longitudinal direction, showing an endoscope 110 of a comparative example. The endoscope 10 has an image pickup element housing tube 22, a water pipe 23, a forceps tube 24 and other members (the endoscope members) disposed in the surrounding of (i.e. provided outside of, with respect to the radial direction of the endoscope 10) the image pickup element 21 (or the image pickup unit 27), to which heat will be detrimental. Disposed outermost is an outermost tube 28. The image pickup unit 27 is composed of the image pickup element 21 and an image pickup element mount board 26, and extracts obtained image data as an electrical signal.

The image pickup element 21 (or the image pickup unit 27) is inserted in the image pickup element housing tube 22, and fixed by filling the interior of the image pickup element housing tube 22 with sealing resin 25 (shown in FIG. 4). In the surrounding of the image pickup element housing tube 22, there are provided a plurality of components such as the water pipe 23 for supplying water to the end face of the endoscope 10, a light guide for emitting light from the end of the endoscope 10, the forceps tube 24 through which a forceps or other instrument is inserted.

Next, a heat transfer path (or a heat transfer configuration) for transferring heat generated in the image pickup element 21 (or the image pickup unit 27) will be described. In the endoscope 10 according to the first embodiment, the heat transferring process is roughly divided into two stages. In the first stage, heat is transferred by a flexible sheet-like heat transfer member 31, and in the second stage, heat is transferred by a heat dissipation member 32. The first stage heat transfer path goes from the image pickup element 21 (or the image pickup unit 27), through the heat transfer member 31, to the image pickup element housing tube 22. The heat transfer member 31 may be a graphite sheet, for example. The heat transfer member 31 is disposed in such a way that at least one end thereof is in contact with the image pickup element 21 (or the image pickup unit 27). The heat transfer member 31 is also in surface contact with the image pickup element housing tube and thermally coupled therewith.

On the other hand, the second stage heat transfer path goes from the image pickup element housing tube 22, through the sheet-like heat dissipation member 32 having flexibility, to members (endoscope members) provided outside the image pickup element housing tube 22. The heat dissipation member 32 may be a graphite sheet, for example. The heat dissipation member 32 is in surface contact with the image pickup element housing tube 22 and thermally coupled therewith. Therefore, the heat transfer member 31 and the heat dissipation member 32 are opposed to each other with the image pickup element housing tube between. The image pickup element housing tube 22 and the members provided outside the image pickup element housing tube (e.g. the water pipe 23 and the forceps tube 24) are coupled by the heat dissipation member 32 in a manner that enables heat exchange. Thus, the heat transferred to the image pickup element housing tube 22 by the first stage heat transfer path is further transferred to the members provided outside the image pickup element housing tube 22 through the heat dissipation member 32.

Although there may be provided only the first stage heat transfer path, it is preferred that the two stage configuration of the heat transfer path be employed to achieve a higher cooling effect. Although, from the viewpoint of heat transfer efficiency, it is preferred that the image pickup element 21 (or the image pickup unit 27) and the heat transfer member 31 be, the heat transfer member 31 and the image pickup element housing tube 22 be, and the image pickup element housing tube 22 and the heat dissipation member 32 be respectively in contact with each other by a large area, they may be arranged in such a way as to be in contact with each other only partially.

The heat transfer member 31 and the heat dissipation member 32 that connect the members in a manner that enables heat exchange and provide heat transfer may be graphite sheets. The heat conductivity of the graphite sheet is approximately 600 to 1700 (W/m.K), which is higher than that of the resin 25 and the image pickup element housing tube 22. Thus, heat generated by the image pickup element 21 (or the image pickup unit 27) is efficiently transferred to the members provided outside the image pickup element housing tube 22. For example, heat is transferred in a radial direction in a cross-section of the endoscope apparatus, from the image pickup element 21 (or the image pickup unit 27) to the heat transfer member 31, then to the image pickup element housing tube 22, then to the heat dissipation member 32, and then to the water pipe 23.

As shown in FIG. 4, since the interior of the image pickup element housing tube 22 is sealed with the resin 25, the heat is scarcely dissipated without the above described heat transfer path. On the other hand, air is present in the space outside the image pickup element housing tube 22, in the interior of the endoscope 10. Therefore, the temperature of the members falls due to heat dissipation into the air. In the endoscope 10, the temperature of the image pickup element housing tube 22 can be decreased by extending the heat dissipation member 32 provided outside the image pickup element housing tube 22 in the longitudinal direction of the endoscope 10 shown in FIG. 3 to thereby promote dissipation of heat to the air. In addition, since the contact of the heat dissipation member 32 and the water pipe 23 enables heat transfer to the water pipe 23 at the same time, heat exchange with the liquid circulating in the water pipe 23 can be achieved. Thus, the image pickup element 21 (or the image pickup unit 27) can be cooled effectively. Although the heat dissipation member 32 is connected with the water pipe 23 in the configuration shown in FIG. 2, the heat dissipation member 32 may be connected to other tube(s) and/or member(s). The heat transfer member 31 and the heat dissipation member 32 are bonded to the endoscope members using an adhesive or the like.

In contrast to the above described endoscope 10, in the case where an endoscope is not provided with a heat transfer path (or heat transfer configuration) for transferring heat generated in the image pickup element 21 (or the image pickup unit 27) as is the case with an endoscope 110 of a comparative example shown in FIG. 4, the heat generated in the image pickup element 21 (or the image pickup unit 27) stays in the resin 25 without being transferred to the surrounding. Therefore, the temperature of the image pickup element 21 (or the image pickup unit 27) is likely to rise. This is because the typical heat conductivity of the resin 25 surrounding the image pickup element 21 (or the image pickup unit 27) is approximately 0.1 to 1 (W/m.K), and heat is harder to be transferred to resin than to metal or ceramic.

### Second Embodiment

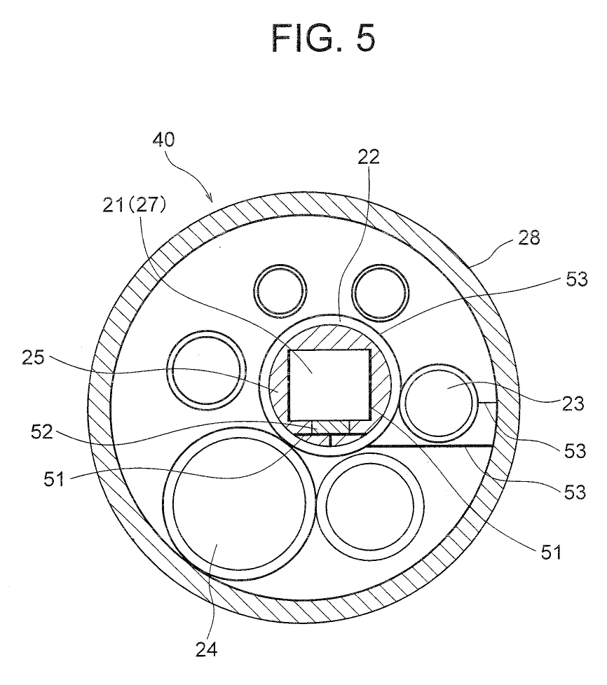

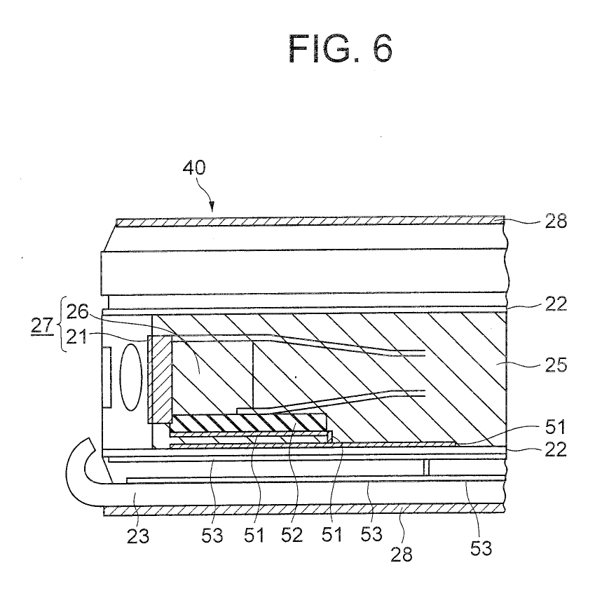

In the following, a second embodiment of the invention will be described with reference to FIGS. 5 and 6. FIG. 5 is a cross sectional view taken on a plane perpendicular to the longitudinal direction, showing the internal structure of the end portion of an endoscope 40 according to the second embodiment, and FIG. 6 is a longitudinal cross sectional view showing the internal structure of the end portion of the endoscope 40.

The endoscope 40 according to the second embodiment differs from the endoscope 10 according to the first embodiment in that the heat transfer member includes a Peltier device 52. Other components of the endoscope 40 according to the second embodiment that are the same as those in the endoscope 10 according to the first embodiment are designated by the same reference numerals, and detailed description thereof will be omitted.

In the endoscope 40 shown in FIGS. 5 and 6, the Peltier device 52 is disposed in such a way that a heat absorbing portion thereof is in contact with the image pickup element 21 (or the image pickup unit 27), and a first graphite sheet 51 is disposed in such a way as to be in surface contact with a heat dissipation portion of the Peltier device 52 and thermally coupled therewith. The first graphite sheet 51 is in surface contact with the image pickup element housing tube 22 and thermally coupled therewith, as is the case with the heat transfer member 31 in the first embodiment. Thus, the first stage heat transfer path through which heat is transferred from the image pickup element 21 (or the image pickup unit 27), through the Peltier device 52, to the first graphite sheet 51, is formed. In other words, the Peltier device 52 and the first graphite sheet 51 constitute a heat transfer member that corresponds to the heat transfer member 31 in the first embodiment.

As is the case with the heat dissipation member 32 in the first embodiment, a second graphite sheet 53 is in surface contact with the image pickup element housing tube 22 and thermally coupled therewith. In this case, it is preferred that the first graphite sheet 51 and the second graphite sheet 53 be opposed to each other with the image pickup element housing tube 22 between to achieve a high heat transfer efficiency. The second graphite sheet 53 is in contact with members (endoscope members) provided outside the image pickup element housing tube 22. Thus, the second stage heat transfer path through which heat is transferred from the image pickup element housing tube 22, through the second graphite sheet 53, to the members provided outside the image pickup element housing tube 22, is formed.

In the case of the endoscope 10 according to the first embodiment, where the heat transfer member 31 and the heat dissipation member 32 are used to lower the temperature of the image pickup element 21 (or the image pickup unit 27), the temperature of the image pickup element 21 cannot be lowered to temperatures below the ambient temperature. In contrast, in the endoscope 40 according to the second embodiment, since the image pickup element 21 (or the image pickup unit 27) is cooled by the Peltier device 52, the temperature of the image pickup element 21 can be lowered below the ambient temperature. Heat absorbed by the Peltier device 52 is transferred to the first graphite sheet 51 from the heat dissipation surface. At this time, it is necessary that the heat transfer member 31 can transfer a larger quantity of heat than in the case of the first embodiment. This is because heat on the heat dissipation surface of the Peltier device needs to be disposed of. Therefore, it is necessary to increase the contact area between the heat transfer member 31 and the image pickup element housing tube 22, or to increase the number of heat transfer paths from the heat dissipation surface of the Peltier device 52 to the image pickup element housing tube 22 by increasing the number of heat transfer members 31. By the above-described heat transfer and heat dissipation, the heat on the heat dissipation surface of the Peltier device 52 can be disposed of.

Components, functions and the advantageous effects of the second embodiment other than those described above are the same as those in the first embodiment.

### Third Embodiment

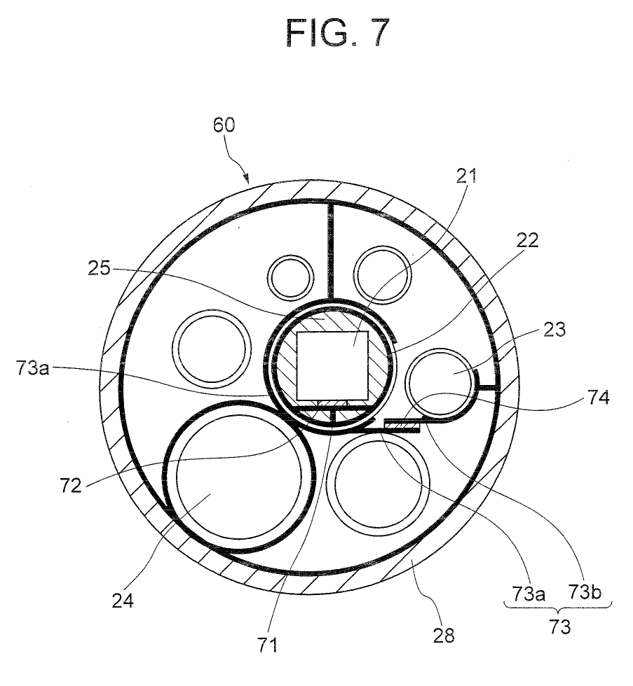

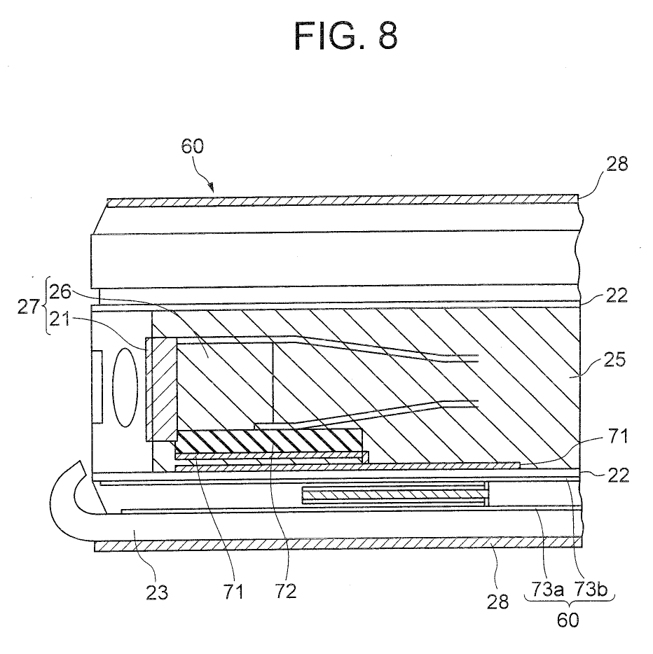

In the following, an endoscope 60 according to a third embodiment of the invention will be described with reference to FIGS. 7 and 8. FIG. 7 is a cross sectional view taken on a plane perpendicular to the longitudinal direction, showing the internal structure of the end portion of the endoscope 60 according to the third embodiment, and FIG. 8 is a longitudinal cross sectional view showing the internal structure of the end portion of the endoscope 60.

The endoscope 60 according to the third embodiment differs from the endoscope 10 according to the first embodiment in that two Peltier devices 72 and 74 are used. Other components of the endoscope 60 according to the third embodiment that are the same as those in the first embodiment are designated by the same reference numerals, and detailed description thereof will be omitted. A first graphite sheet 71 and the Peltier device 72 correspond to the first graphite sheet 51 and the Peltier device 52 in the second embodiment, respectively.

In the endoscope 60, the second graphite sheet 73 is composed of an image pickup element housing tube side sheet 73a that is in surface contact with the image pickup element housing tube 22 and thermally coupled therewith and a water pipe side sheet 73b that is in surface contact with the water tube 23 and thermally coupled therewith. The image pickup element housing tube side sheet 73a is connected with the heat absorbing portion of the Peltier device 74, and the water pipe side sheet 73b is connected with the heat dissipation portion of the Peltier device 74.

As described above, by providing the Peltier device 74 disposed outside the image pickup element housing tube 22, heat discharged from the Peltier device 72 disposed inside the image pickup element housing tube 22 can be disposed of. Since the space outside the image pickup element housing tube 22 is sufficiently large as compared to the space inside the image pickup element housing tube 22, it provides a wider range of choice in terms of the size of the Peltier device 74. The cooling capability of the typical Peltier device tends to increase with an increase in its size. Therefore, heat discharged from the Peltier device 72 can be efficiently disposed of by employing a large Peltier device 74. On the other hand, in the case where the Peltier device 74 is used, it is necessary to dispose of heat on the heat dissipation surface of the Peltier device 74. However, there are many members having higher heat conductivities than the resin and many members to which heat is transferred outside the image pickup element housing tube 22, and therefore heat on the heat dissipation surface of the Peltier device 74 can be disposed of more easily than in the case of the second embodiment.

Components, functions and the advantageous effects of the third embodiment other than those described above are the same as those in the first and second embodiments.

### Fourth Embodiment

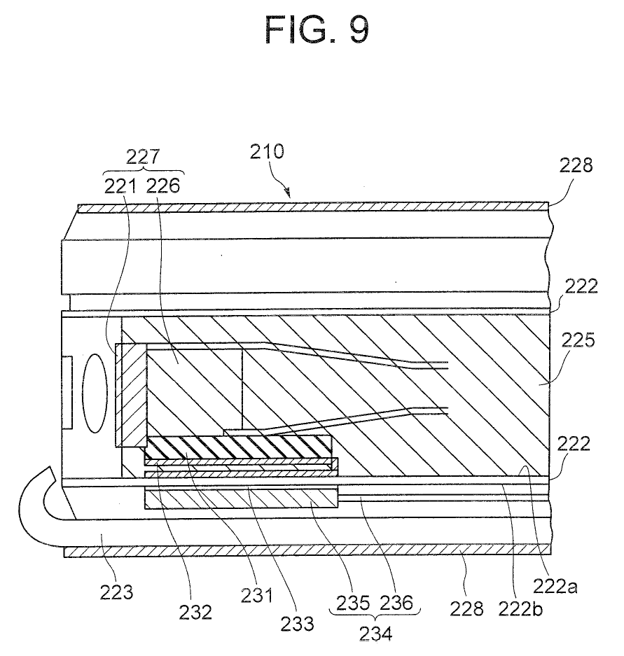

A fourth embodiment of the invention will be described with reference to FIGS. 9 to 11.

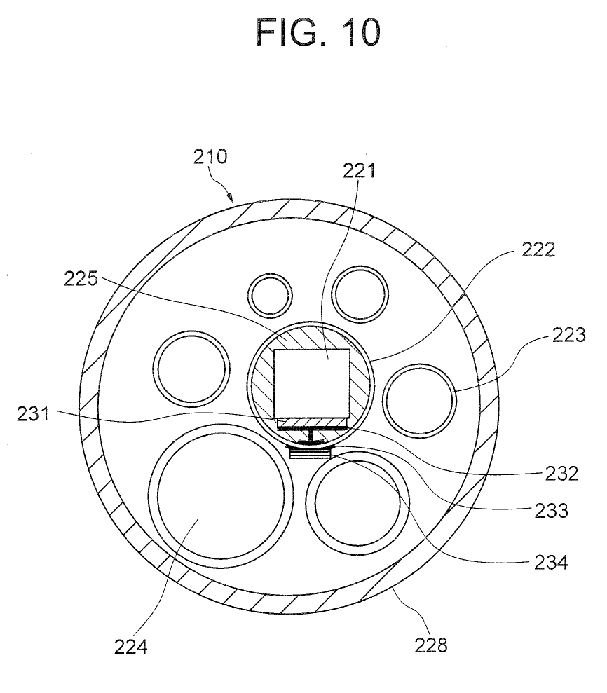

FIG. 9 is a longitudinal cross sectional view showing the internal structure of the end portion of an endoscope 210 (endoscope apparatus) according to the fourth embodiment. FIG. 10 is a cross sectional view taken on a plane perpendicular to the longitudinal direction, showing the internal structure of the end portion of the endoscope 210 according to the fourth embodiment. Detailed description of other components of the endoscope 210 that are the same as those in the first to third embodiments will be omitted.

An image pickup element housing tube 222 will be described with reference to FIGS. 9 and 10. In the image pickup element housing tube 222, an image pickup element 221, an image pickup element mount board 226, a Peltier device 231 (or a heat transfer member), and a first heat transfer member 232 are disposed. The interior of the image pickup element housing tube 222 is sealed with the resin 225. A water pipe 223, a forceps tube 224, and an outermost tube 228 correspond to the water pipe 23, the forceps tube 24, and the outermost tube 28 in the first embodiment, respectively.

The cooling surface of the Peltier device 231 is attached to the image pickup element mount board 226, and the heat dissipation surface of the Peltier device 231 is attached to one end of the first heat transfer member 232. The other end of the first heat transfer member 232 is attached to an inner wall surface 222a of the image pickup element housing tube 222. These surfaces are attached to each other using an adhesive or the like. The first heat transfer member 232 is disposed in such a way as to extend in a radial direction of the image pickup element housing tube 222 or in a radial direction of the endoscope 210.

In the above described configuration, heat on the heat dissipation surface of the Peltier device 231 is transferred to the image pickup element housing tube 222 through the first heat transfer member 232. Thus, the temperature of the image pickup element 221 (or the image pickup unit 227) can be lowered.

The heat conductivity of the first heat transfer member 232 is designed to be higher than that of the resin 225. This prevents heat on the heat dissipation surface of the Peltier device 231 from spreading in the resin 225, and efficient heat transfer to the image pickup element housing tube 222 is not prevented. Therefore, heat on the heat dissipation surface of the Peltier device 231 tends to be efficiently transferred to the image pickup element housing tube 222 through the first heat transfer member 232.

It is preferred that the first heat transfer member 232 be flexible and have a high heat conductivity. As such a material, for example, a graphite sheet may be used. The flexibility of the first heat transfer member 232 makes it easy to provide the adhesive surface between the first heat transfer member 232 and the Peltier device 231 and the image pickup element housing tube 222, and enables a complex configuration in which the first heat transfer member 232 passes through gaps between members inside the image pickup element housing tube 222.

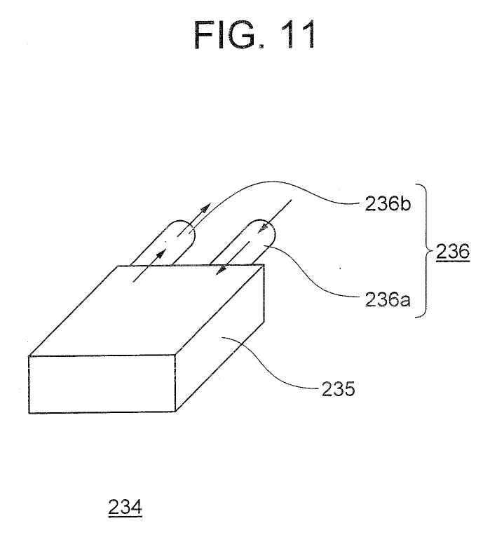

Next, a heat exchange system 234 will be described with reference to FIG. 11. FIG. 11 is a perspective view showing the structure of the heat exchange system 234 according to the fourth embodiment.

The heat exchange system 234 is disposed in such a way as to further transfer heat transferred from the image pickup element 221 (or the image pickup unit 227) to the image pickup element housing tube 222 by heat exchange. By transferring heat in the image pickup element housing tube 222 further, the temperature of the image pickup element housing tube 222 can be lowered, and heat transfer from the image pickup unit 221 to the image pickup element housing tube 222 can be promoted.

The heat exchange system 234 is composed of a water cooling system 235 and tubes 236. The tubes 236 are connected to the water cooling system 235. The tubes 236 include two tubes 236a and 236b, or the tube 236a used to supply water to the water cooling system 235, and the tube 236b used to discharge water from the water cooling system 235. These tubes extend along the longitudinal direction of the endoscope 210. Thus, water is supplied to the water cooling system 235 from the rear side of the endoscope 210 with respect to the longitudinal direction.

The image pickup element housing tube 222 and the heat exchange system 234 are attached to each other by bonding the image pickup element housing tube 222 to the water cooling system 235using an adhesive 233. Furthermore, the water cooling system 235 is attached to the image pickup element housing tube 222 in such a way as to be opposed to the first heat transfer member 232 with the inner wall surface 222a and the outer wall surface 222b of the image pickup element housing tube 222 between.

It is preferred that water cooling system 235 be one that can transfer a large quantity of heat.

The water cooling system 235 is provided with a flow passage or channel inside it, and heat exchange is achieved by flow of water in the flow passage. The water cooling system 235 having the above-described structure is produced by preparing two metal members, making the flow passage on one of the metal members by cutting or sandblast, joining the two metal members together, and fixing them to each other. The fixing may be achieved by bonding them using an adhesive or bonding them by applying pressure at high temperature. The structure may be produced as an integral structure by electroforming.

It is preferred that the water cooling system 235 have a high heat conductivity and be made of a metal having a heat conductivity not lower than 1 (W/m·K). It is preferred that the metal have high resistance against rust and corrosion, because water, oil or the like flows through the water cooling system 235. The water cooling system 235 and the tubes 236 are joined using an adhesive or the like.

In the heat exchange system 234, water for heat exchange flows in the direction indicated by arrows in FIG. 11. The water is supplied in a pressurized state to circulate by flowing from the rear side of the endoscope 210 with respect to the longitudinal direction to the water cooling system 235 through the supply tube 236a, and then flowing from the water cooling system 235 to the rear side of the endoscope 210 with respect to the longitudinal direction through the return tube 236b.

The tubes 236 extend from one end of the water cooling system 235 to the rear side of the endoscope 210 with respect to the longitudinal direction. The water is pressurized by a pump provided in the exterior or interior of the endoscope 210. It is preferred that the material of the tubes 236 be flexible so that they can follow bending of the endoscope 210. For example, the tubes 236 maybe silicon tubes. The water or liquid that flows in the tubes 236 is not limited to pure water, but it may be oil or other kinds of liquid.

With the above described structure, the image pickup element 221 (or the image pickup unit 227) can be efficiently cooled without an increase in size of the endoscope with respect to the diametrical direction, and therefore heat noise in the image pickup element 221 can be reduced.

### Fifth Embodiment

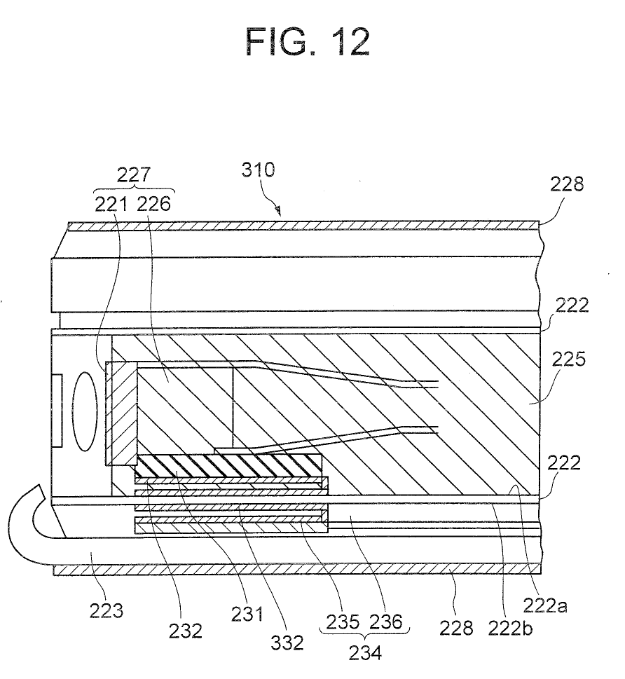

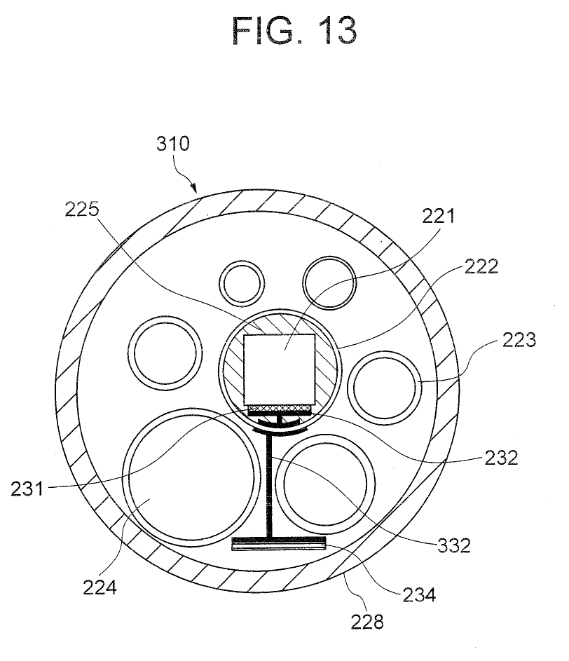

Next, a fifth embodiment of the invention will be described with reference to FIGS. 12 and 13. FIG. 12 is a longitudinal cross sectional view showing the internal structure of the end portion of an endoscope 310 (or an endoscope apparatus) according to the fifth embodiment. FIG. 13 is a cross sectional view taken on a plane perpendicular to the longitudinal direction, showing the internal structure of the end portion of the endoscope 310 according to the fifth embodiment. Other components of the endoscope 310 according to the fifth embodiment that are the same as those in the forth embodiment are designated by the same reference numerals, and detailed description thereof will be omitted.

If it is possible to arrange the heat exchange system 234 in such a way as to be in contact with the image pickup element housing tube 222 as is the case with the endoscope 210 according to the fourth embodiment, the heat exchange system 234 and the image pickup element housing tube 222 may be attached to each other as shown in FIGS. 9 and 10. On the other hand, if it is not possible to attach the heat exchange system 234 to the image pickup element housing tube 222, a second heat transfer member 332 is used to transfer heat from the image pickup element housing tube 222 outwardly with respect to the radial direction of the endoscope 310, and heat exchange is performed by the heat exchange system 234, which is the case with the endoscope 310 according to the fifth embodiment shown in FIGS. 12 and 13.

Specifically, one end of the second heat transfer member 332 is attached to the outer wall surface 222b of the image pickup element housing tube 222, and the other end thereof is attached to the heat exchange system 234. It is preferred that an adhesive or the like be used to bond them. The second heat transfer member 332 is opposed to the water cooling system 235, and is also opposed to the first heat transfer member 232 with the inner wall surface 222a and the outer wall surface 222b of the image pickup element housing tube 222 between.

As described above, since the second heat transfer member 332 extends outwardly in the radial direction of the endoscope 310, it can transfer heat in the image pickup element housing tube 222 to a region where a space large enough to accommodate the heat exchange system 234 is available, thereby enabling water cooling. In this configuration, cooling of the image pickup element 221 can be achieved by transferring heat in the image pickup element 221 to the heat exchange system 234 in two stages, namely first from the image pickup element 221 (or the image pickup unit 227) to the image pickup element housing tube 222, and then from the image pickup element housing tube 222 to the heat exchange system 234, where heat exchange is performed.

It is preferred that the second heat transfer member 332 be flexible as with the first heat transfer member 232. The second heat transfer member 332 may be, for example, a graphite sheet. The flexibility of the second heat transfer member 332 enables a configuration in which the second heat transfer member 332 passes through gaps between members disposed around the image pickup element housing tube 222. Thus, the degree of freedom of arrangement of the heat exchange system 234 is increased. It is preferred that the second heat transfer member 332 have a higher heat conductivity. The higher the heat conductivity of the second heat transfer member 332 is, the farther the heat of the image pickup element housing tube 222 can be transferred away.

With the above described configuration, efficient cooling of the image pickup element 221 (or the image pickup unit 227) can be achieved without an increase in size of the endoscope 310 with respect to the diametrical direction, and therefore heat noise in the image pickup element 221 can be reduced.

As described in the foregoing, the endoscope apparatus according to the present invention is advantageous when applied to an endoscope apparatus in that the built-in image pickup element can be efficiently cooled without an increase in the diametrical size of the endoscope apparatus.

The endoscope apparatus according to the present invention has an advantage that an image pickup unit in the endoscope apparatus can be cooled without in increase in the size of the endoscope apparatus by transferring heat of the image pickup unit in a radial direction.

What is claimed is:

1. An endoscope apparatus comprising:
an image pickup unit;
an image pickup element housing tube that houses the image pickup unit;
a heat transfer member that is in contact with the image pickup unit and the image pickup element housing tube; and
a resin that is in contact with the image pickup unit and seals the interior of the image pickup element housing tube, wherein
the heat transfer member has a heat conductivity higher than that of the resin.

2. The endoscope apparatus according to claim 1, wherein the heat transfer member is a flexible sheet-like structure.

3. The endoscope apparatus according to claim 2, wherein the image pickup element housing tube and an endoscope member disposed radially outside the image pickup element housing tube in the endoscope apparatus are in contact with a heat dissipation member having a heat conductivity higher than that of the image pickup element housing tube.

4. The endoscope apparatus according to claim 3, wherein the transfer member is composed of a Peltier device and a flexible sheet-like structure.

5. The endoscope apparatus according to claim 4, wherein the heat transfer member and the heat dissipation member are opposed to each other with the image pickup element housing tube between.

6. The endoscope apparatus according to claim 4, wherein the endoscope member disposed radially outside the image pickup element housing tube is a water supply tube.

7. The endoscope apparatus according to claim 4, wherein the heat dissipation member is composed of a Peltier device and a flexible sheet-like structure.

8. The endoscope apparatus according to claim 1, wherein
the heat transfer member comprises a Peltier device that is in contact with the image pickup unit and a first heat transfer member that is in contact with the Peltier device at one end and extends in a radial direction of the image pickup element housing tube,
an inner wall surface of the image pickup element housing tube is in contact with the other end of the first heat transfer member, and
the image pickup unit, the Peltier device, and the first heat transfer member are sealed by the resin in the image pickup element housing tube.

9. The endoscope apparatus according to claim 8, wherein the Peltier device has a cooling surface that is in contact with the image pickup unit and a heat dissipation surface that is in contact with one end of the first heat transfer member.

10. The endoscope apparatus according to claim 9, further comprising a heat exchange system that is in contact with an outer wall surface of the image pickup element housing tube.

11. The endoscope apparatus according to claim 10, wherein the first heat transfer member and the second heat transfer member are flexible.

12. The endoscope apparatus according to claims 11, wherein the first heat transfer member and the second heat transfer member are graphite sheets.

13. The endoscope apparatus according to claims 12, wherein the first heat transfer member has a heat conductivity higher than that of the resin.

14. The endoscope apparatus according to claim 13, wherein the heat exchange system comprises a water cooling system and a tube.

15. The endoscope apparatus according to claim 8, further comprising a second heat transfer member that is in contact with an outer wall surface of the image pickup element housing tube at one end and extends in a radial direction of the image pickup element housing tube, and a heat exchange system that is in contact with the other end of the second heat transfer member.

16. The endoscope apparatus according to claim 15, wherein the first heat transfer member and the second heat transfer member are flexible.

17. The endoscope apparatus according to claim 16, wherein the first heat transfer member and the second heat transfer member are graphite sheets.

18. The endoscope apparatus according to claim 17, wherein the first heat transfer member has a heat conductivity higher than that of the resin.

19. The endoscope apparatus according to claims 18, wherein the heat exchange system comprises a water cooling system and a tube.

20. The endoscope apparatus according to claim 8, wherein the first heat transfer member and the water cooling system are opposed to each other with an inner wall surface and an outer wall surface of the image pickup element housing tube between.
